(19) United States
(12) Patent Application Publication
(10) Pub. No.: US 2026/0261622 A1
(43) Pub. Date: Sep. 3, 2026

(54) COLOR CONVERSION METHOD, COLOR CONVERSION DEVICE, AND NON-TRANSITORY COMPUTER-READABLE STORAGE MEDIUM STORING PROGRAM

(71) Applicant: SEIKO EPSON CORPORATION, TOKYO (JP)

(72) Inventors: Takuya ONO, SHIOJIRI-SHI (JP); Takahiro KAMADA, MATSUMOTO-SHI (JP); Mitsuhiro YAMASHITA, MATSUMOTO-SHI (JP); Yuko YAMAMOTO, SHIOJIRI-SHI (JP)

(21) Appl. No.: 19/553,493

(22) Filed: Mar. 2, 2026

(30) Foreign Application Priority Data
Feb. 28, 2025 (JP) 2025-031313

(51) Int. Cl. H04N 1/60

(52) U.S. Cl. CPC H04N 1/6025; H04N 1/6008; H04N 1/603

(57) ABSTRACT

A color conversion method includes: (c) when an instruction to hold black print is received, executing black print holding correction for correcting a color conversion table to increase a K component and decrease a non-target color component in an output value associated with a target grid point that is a grid point representing a single-color input value in the color conversion table; and (d) executing spread correction for spreading the black print holding correction to a spread grid point in a predetermined range around the target grid point among grid points representing an input value in the color conversion table, which is spread correction for correcting an output value associated with the spread grid point in the color conversion table by using an increase amount of the K component caused by the black print holding correction and a substitution rate table in which a color component substitution rate is defined for the non-target color component to limit a color variation caused by the spread correction.

The present application is based on, and claims priority from JP Application Serial Number 2025-031313, filed Feb. 28, 2025, the disclosure of which is hereby incorporated by reference herein in its entirety.

### BACKGROUND

### 1. Technical Field

The present disclosure relates to a color conversion method, a color conversion device, and a non-transitory computer-readable storage medium storing a program.

### 2. Related Art

In printing, black print holding, gray component replacement (GCR), and the like may be required. JP-A-2022-32516 describes a technique for controlling an amount of black in a printing device. The control for the amount of black is to adjust an ink amount of black for the purpose of improving a printing quality. In the technique described in JP-A-2022-32516, a table for converting CMY values into Lab values is created based on a color conversion table called AtoBTag included in an output profile and the calculated ink amount of black, and CMY values corresponding to the Lab values of an image are searched from this table. Accordingly, the CMY values reproducing the Lab values are calculated while controlling the ink amount of black by a calculation formula.

JP-A-2022-32516 is an example of the related art.

There is a multicolor profile in which the number of color channels that can be supported is larger than four colors of process colors. In the multicolor profile, the number of grid points of AtoBTag increases exponentially according to the number of color channels. As the number of grid points increases, a data size of AtoBTag becomes very large, and thus it is practically difficult to store AtoBTag in a color profile. Therefore, in the case of the multicolor profile, it is difficult to adopt the method using AtoBTag described in JP-A-2022-32516 to adjust an ink amount of a specific color such as black.

### SUMMARY

The present disclosure can be implemented according to the aspects given below.

According to a first aspect of the present disclosure, a color conversion method is provided. The color conversion method includes: (a) receiving an instruction to hold black print; (b) preparing a color conversion table defining an association between an input value in an input color space in image data and an output value in an output color space in a printing device that prints an image represented by the image data; (c) when the instruction is received and a single-color input value that is the input value including only a K component in the image data is converted into the output value including a non-target color component that is a color component other than the K component by color conversion using the color conversion table, executing black print holding correction for correcting the color conversion table to increase the K component and decrease the non-target color component in the output value associated with a target grid point that is a grid point representing the single-color input value in the color conversion table; and (d) executing spread correction for spreading the black print holding correction to a spread grid point in a predetermined range around the target grid point among grid points representing the input value in the color conversion table, which is spread correction for correcting the output value associated with the spread grid point in the color conversion table by using an increase amount of the K component caused by the black print holding correction and a substitution rate table in which a color component substitution rate is defined for the non-target color component to limit a color variation caused by the spread correction.

According to a second aspect of the present disclosure, a color conversion device is provided. The color conversion device includes: a selection unit configured to receive an instruction to hold black print; a table creation unit configured to create a color conversion table defining an association between an input value in an input color space in image data and an output value in an output color space in a printing device that prints an image represented by the image data; and a correction unit configured to, when the instruction is received and a single-color input value that is the input value including only a K component in the image data is converted into the output value including a non-target color component that is a color component other than the K component by color conversion using the color conversion table, execute black print holding correction for correcting the color conversion table to increase the K component and decrease the non-target color component in the output value associated with a target grid point that is a grid point representing the single-color input value in the color conversion table, and execute spread correction for spreading the black print holding correction to a spread grid point in a predetermined range around the target grid point among grid points representing the input value in the color conversion table, which is spread correction for correcting the output value associated with the spread grid point in the color conversion table by using an increase amount of the K component caused by the black print holding correction and a substitution rate table in which a color component substitution rate is defined for the non-target color component to limit a color variation caused by the spread correction.

According to a third aspect of the present disclosure, a program executed by a computer is provided. A non-transitory computer-readable storage medium storing the program for causing the computer to execute: a function of receiving an instruction to hold black print; a function of creating a color conversion table defining an association between an input value in an input color space in image data and an output value in an output color space in a printing device that prints an image represented by the image data; and when the instruction is received and a single-color input value that is the input value including only a K component in the image data is converted into the output value including a non-target color component that is a color component other than the K component by color conversion using the color conversion table, a function of executing black print holding correction for correcting the color conversion table to increase the K component and decrease the non-target color component in the output value associated with a target grid point that is a grid point representing the single-color input value in the color conversion table, and a function of executing spread correction for spreading the black print holding correction to a spread grid point in a predetermined range around the target grid point among grid points representing the input value in the color conversion table, which is spread correction for correcting the output value associated with the spread grid point in the color conversion table by using an increase amount of the K component caused by the black print holding correction and a substitution rate table in which a color component substitution rate is defined for the non-target color component to limit a color variation caused by the spread correction.

### BRIEF DESCRIPTION OF THE DRAWINGS

FIG. 1 is a diagram showing a printing system.

FIG. 2 is a diagram showing an example of a configuration of an image processing device.

FIG. 3 is a diagram showing a color cube expressing a CMYK color space in a cube shape.

FIG. 4 is a diagram showing an example of normal color conversion.

FIG. 5 is a diagram showing an example of color conversion using a color conversion LUT.

FIG. 6 is a flowchart showing an overall processing flow of color correction processing.

FIG. 7 is a diagram showing an example of a selection GUI displayed on a display device.

FIG. 8 is a flowchart showing a specific processing flow (first half) of step S30 in FIG. 6.

FIG. 9 is a flowchart showing a specific processing flow (second half) of step S30 in FIG. 6.

FIG. 10 is a diagram of grid points on a KC plane.

FIG. 11 shows an example of a substitution rate table.

FIG. 12 shows another example of the substitution rate table.

### DESCRIPTION OF EMBODIMENTS

### A. Embodiment

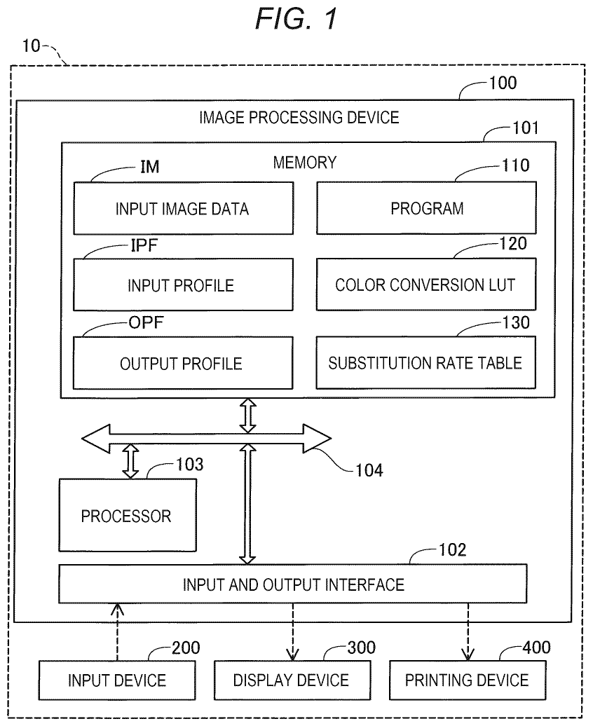

FIG. 1 is a diagram showing a printing system 10. The printing system 10 includes an image processing device 100, an input device 200, a display device 300, and a printing device 400.

The image processing device 100 is a computer including a memory 101, an input and output interface 102, a processor 103, and an internal bus 104. The memory 101, the input and output interface 102, and the processor 103 are bidirectionally communicably coupled to one another via the internal bus 104. The memory 101 stores various programs and various types of data used for various types of processing executed by the image processing device 100. In the shown example, the memory 101 stores input image data IM to be printed, an input profile IPF, an output profile OPF, a program 110, a color conversion look up table (LUT) 120, and a substitution rate table 130. Details of the program 110, the color conversion LUT 120, and the substitution rate table 130 will be described later. The input device 200, the display device 300, and the printing device 400 are coupled to the input and output interface 102 by wired communication or wireless communication. The color conversion LUT 120 is also referred to as a “color conversion table”.

The input profile IPF is used for color conversion from an input color space used in image data to a device independent color space. The input color space is, for example, a CMYK color space or an RGB color space. The device independent color space is, for example, a CIE-L^{*}a^{*}b^{*} color space or a CIE-XYZ color space. Hereinafter, the CIE-L^{*}a^{*}b^{*} color space is simply referred to as a Lab color space. L^{*}a^{*}b^{*} is simply referred to as Lab. In the color conversion using the input profile IPF, an input value that is a value representing a color in the input color space of each pixel included in the image data is converted into a color specification value that is a value representing a color in the device independent color space of each pixel.

The output profile OPF is used for color conversion from the device independent color space to the output color space for the printing device 400. The output color space is, for example, a CMYK color space. In the color conversion using the output profile OPF, a color specification value that is a value representing a color in the device independent color space of each pixel included in the image data is converted into an output value representing a color of each pixel in the output color space used in the printing device 400. In the embodiment, the output profile OPF is created by combining a general output profile and an ink amount conversion LUT. The general output profile is an output profile created by the International Color Consortium (ICC) or an output profile conforming to an ICC specification. The output profile OPF corresponds to multicolor. In the color conversion using the output profile OPF, a color specification value in the device independent color space is converted into an ink amount of the printing device.

The input device 200 is, for example, a keyboard or a mouse. The display device 300 is, for example, a liquid crystal display or an organic electro luminescence (EL) display. A graphical user interface (GUI) described later is displayed on the display device 300. The input device 200 and the display device 300 are used to receive an operation instruction related to printing from a user described later.

The printing device 400 is an inkjet type printing device. The printing device 400 executes printing using a CMYKLcLmLk ink. A typical printing device uses a process ink that is a color material of a process color CMYK, but the printing device 400 uses the LcLmLk ink in addition to the process color CMYK. C is cyan, M is magenta, Y is yellow, K is black, Lc is light cyan, Lm is light magenta, and Lk is light black. The light cyan is a cyan ink having a low density. The light magenta is a magenta ink having a low density. The light black is a black ink having a low density. In the present specification, the “multicolor” means to include four or more process colors.

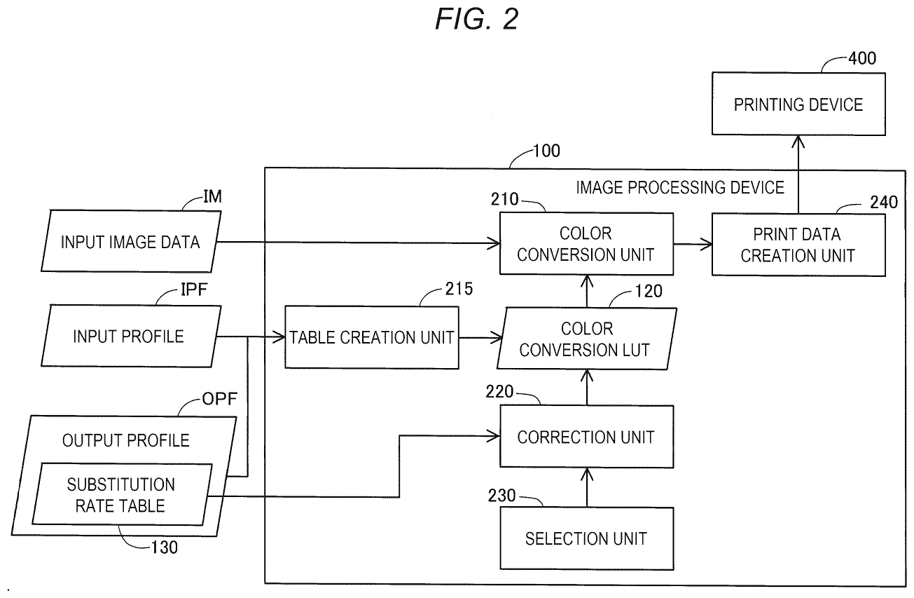

FIG. 2 is a diagram showing an example of a configuration of the image processing device 100. The image processing device 100 includes a color conversion unit 210, a table creation unit 215, a correction unit 220, a selection unit 230, and a print data creation unit 240. When the processor 103 executes the program 110 stored in advance in the memory 101, functions of these units are implemented.

The color conversion unit 210 executes, on the image data, color conversion processing for converting the input value in the input color space into the output value in the output color space by using the color conversion LUT 120. In the embodiment, the input color space is the CMYK color space used in the input image data IM. The output color space is a CMYKLcLmLk color space used in the printing device 400.

The color conversion LUT 120 is a lookup table for converting the input value in the input color space into the output value in the output color space. The color conversion LUT 120 is created by combining the input profile IPF and the output profile OPF. The color conversion LUT 120 is created when executing the color conversion. By combining the input profile IPF and the output profile OPF, the processing can be executed at high speed in the color conversion processing. By directly converting the input color space into the output color space, it is possible to easily perform LUT correction processing such as black print holding correction described later.

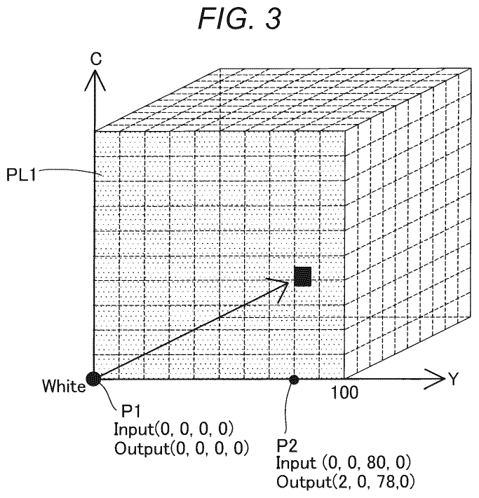

FIG. 3 is a diagram showing a color cube conceptually expressing the CMYK color space in a cube shape. Here, an example in which both the input color space and the output color space are the CMYK color space will be described. The color cube has an origin of White (paper white) and is defined by three coordinate axes of a C axis, an M axis, and a Y axis orthogonal to one another. Since the CMYK color space is a four-dimensional space, for example, a plane PL1 in which an M component is 0 constitutes a hyperplane of the four-dimensional space. Since it is difficult to show such a hyperplane, the hyperplane is represented by a plane of a three-dimensional space in FIG. 3. FIG. 3 does not show a portion of grid lines.

A plurality of grid points are set in the color cube. Each grid point corresponds to an input value in the input color space. More specifically, the grid point indicates a coordinate value representing a component value of each color component when a coordinate axis representing the color component is set in the input color space. Coordinates of the grid point represent an input value (C, M, Y, K) in the color conversion LUT 120. Each grid point is associated with the output value in the output color space corresponding to the input value in the color conversion LUT 120. In the embodiment, the output value of the color conversion LUT 120 represents an ink amount of each ink. The ink amount is represented by a duty value of the ink. The duty value of the ink indicates the amount of the ink per unit area ejected onto a medium. A possible range of the duty value is 0 to 100%. In the shown example, an input value (0, 0, 0, 0) of each component of CMYK and an output value (0, 0, 0, 0) of each component of CMYK are represented for a grid point P1, and an input value (0, 0, 80, 0) of each component of CMYK and an output value (2, 0, 78, 0) of each component of CMYK are represented for a grid point P2.

For an input value in which a value other than K is zero, it may be desired to print with only the black ink. Therefore, the black print holding may be executed.

In the color conversion using the created initial color conversion LUT 120, an input value in which a value other than K is zero is not necessarily an output value in which a value other than K is zero (see the grid point P2 in FIG. 3). Therefore, it is necessary to correct the color conversion LUT 120 by a method to be described later in order to enable printing with only the black ink for the input value in which the value other than K is zero.

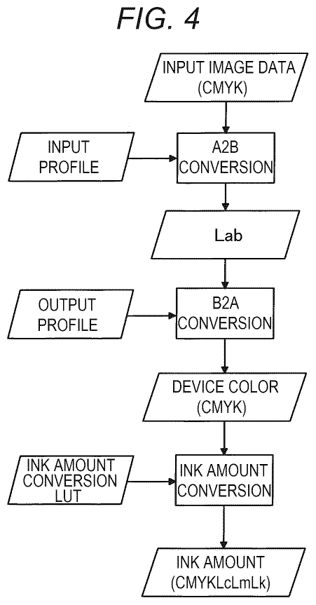

FIG. 4 is a diagram showing an example of normal color conversion. FIG. 4 shows an example in which the color conversion via the device independent color space is executed in the order of A2B conversion and B2A conversion, and then the conversion into the ink amount is performed using the ink amount conversion lookup table. Here, the A2B conversion is to convert a CMYK value into a color specification value in the device independent color space using AtoBTag. The B2A conversion is to convert a color specification value in the device independent color space into a CMYK value using BtoATag.

When the A2B conversion and the B2A conversion are executed, for example, an input value indicated by a grid point of an index (0, 0, 0, 2) is converted into a CMYK (20, 20, 40, 10) as an output value. Thereafter, when the conversion into the ink amount is executed using the ink amount conversion LUT, for example, the input value indicated by the grid point of the index (0, 0, 0, 2) is finally converted into an ink (0, 0, 0, 20, 0, 0, 40) representing each ink amount of CMYKLcLmLk. The value of the index represents the coordinate values of the grid point. The index (0, 0, 0, 2) indicates that the coordinate values other than a K axis are zero.

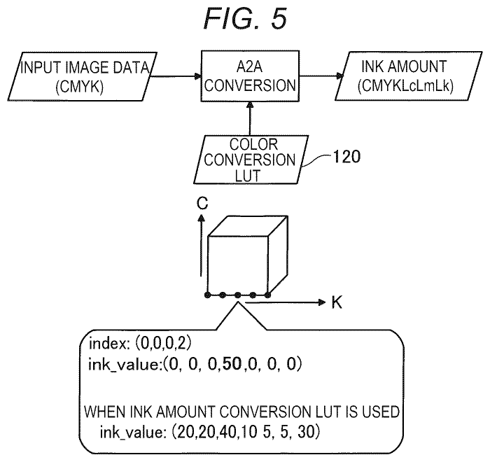

FIG. 5 is a diagram of the color conversion using the color conversion LUT 120. The color conversion LUT 120 is an LUT corrected to enable the black print holding. In the color conversion using the color conversion LUT 120, the CMYK value as an input value is converted into each ink amount of CMYKLcLmLk.

As shown in FIG. 2, for example, the table creation unit 215 creates the color conversion LUT 120 by combining the input profile IPF and the output profile OPF before the printing device 400 executes the first printing. In the example shown in FIG. 2, the substitution rate table 130 is included in the output profile OPF, but the substitution rate table 130 may be outside the output profile OPF.

The correction unit 220 corrects the color conversion LUT 120 to enable the black print holding.

The correction unit 220 executes the following correction processing on the color conversion LUT 120 when the selection unit 230 receives an instruction to hold the black print. The output value to be corrected in the color conversion LUT 120 is each ink amount of CMYKLcLmLk. Although a specific content of the processing will be described later, in the color conversion LUT 120, when the input value is a single-color input value including only a K component and the output value includes a non-target color component, the correction unit 220 corrects the color conversion LUT 120 by increasing the K component in the output value and decreasing the non-target color component in the output value. The “non-target color component” is a color component other than the K component. Here, decreasing the non-target color component in the output value means decreasing at least one of the color components other than the K component. By this correction, the ink amount as the output value associated with the grid point on the K axis is corrected. This correction is also referred to as “black print holding correction”.

Further, the correction unit 220 corrects output values associated with grid points around the grid point representing the single-color input value in which the input value includes only the K component. This correction is also referred to as “spread correction”. In the color conversion processing using the color conversion LUT 120 in which only the output value associated with the grid point on the K axis is corrected, tone jump may occur. The spread correction is executed in order to prevent the occurrence of the tone jump caused by the black print holding.

The selection unit 230 receives, from the user, an instruction to hold the black print.

The print data creation unit 240 converts an ink amount of each ink represented by the color-converted image data into ink dots (ink droplets), and creates print data to be supplied to the printing device 400.

The printing device 400 executes printing according to the print data supplied from the print data creation unit 240.

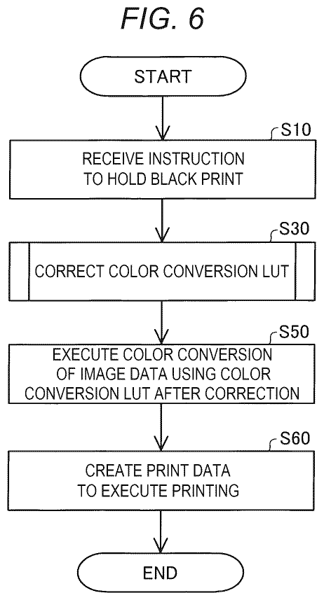

FIG. 6 is a flowchart showing a flow of overall color correction processing. The color conversion LUT 120 is created at the time when the processing shown in FIG. 6 is started.

In step S10, the selection unit 230 receives an instruction to hold black print.

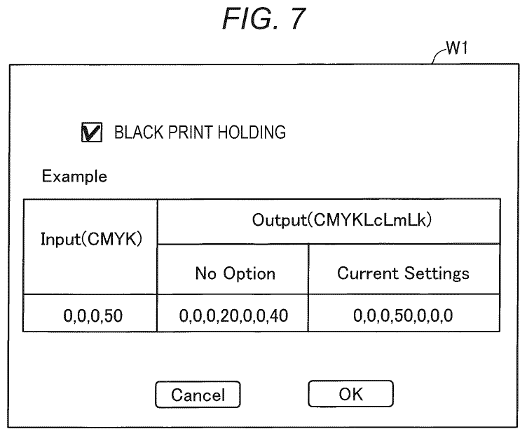

FIG. 7 is a diagram showing an example of a selection screen W1 displayed on the display device 300. The selection unit 230 displays the selection screen W1 on the display device 300. The user uses the input device 200 to instruct whether to execute the black print holding. Here, it is assumed that the user instructs to execute the black print holding.

As shown in FIG. 6, in step S30, the correction unit 220 corrects the content of the color conversion LUT 120. In step S50, the color conversion unit 210 executes the color conversion of image data to be printed using the color conversion LUT 120 after the correction. In step S60, the print data creation unit 240 creates, based on the color-converted image data, print data to be supplied to the printing device 400. The printing device 400 executes printing according to the print data supplied from the print data creation unit 240.

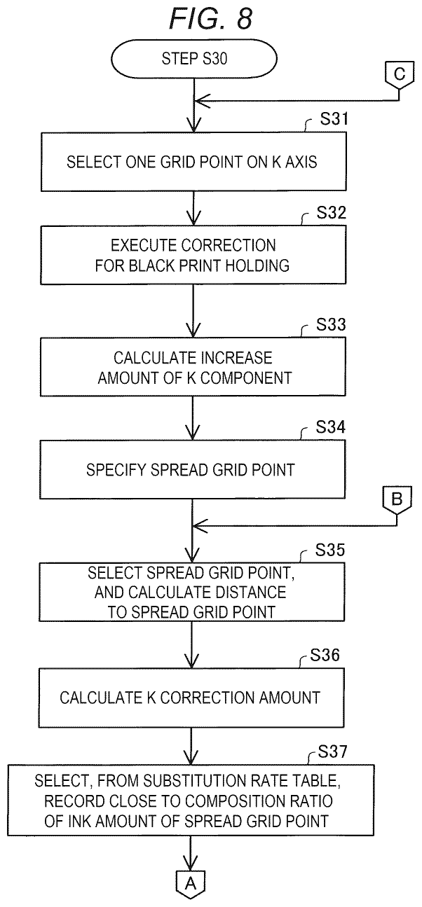

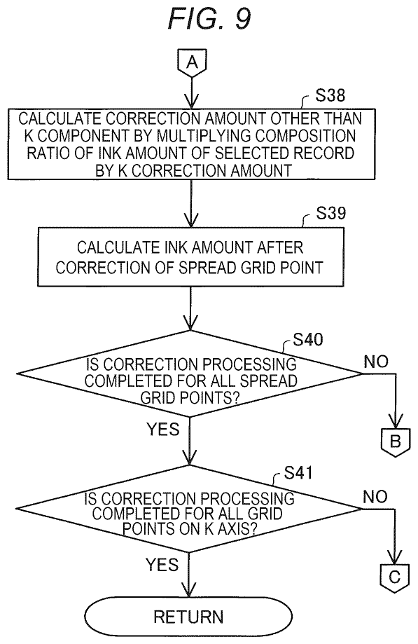

FIGS. 8 and 9 are flowcharts showing a flow of specific processing of step S30.

In step S31, the correction unit 220 selects one grid point on the K axis among a plurality of grid points distributed in the CMYK color space for input. Coordinates of each grid point correspond to the input value CMYK in the color conversion LUT 120, and each ink amount of CMYKLcLmLk as the output value corresponding to the input value in the color conversion LUT 120 is associated with the grid point. The grid point on the K axis is a grid point in which the color component other than the K component in the input value is zero in the color conversion LUT 120.

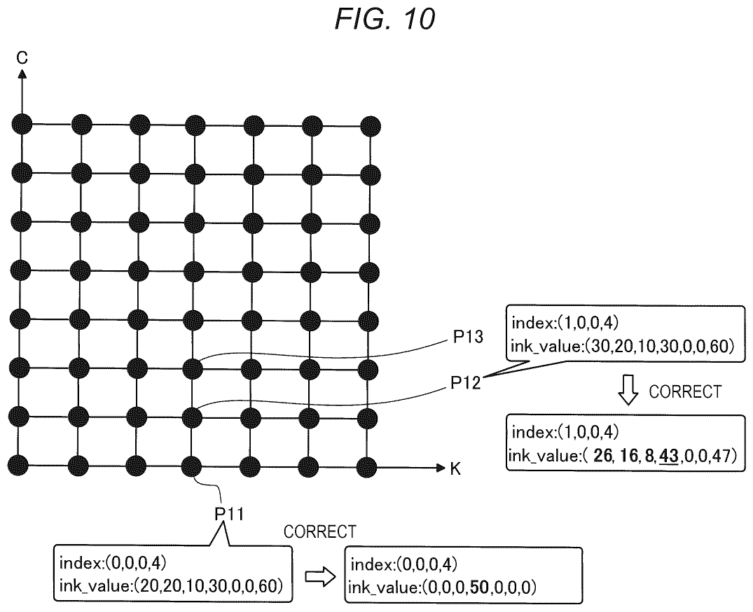

FIG. 10 is a diagram of grid points on a KC plane. For example, a grid point P11 of an index (0, 0, 0, 4) is selected. Each ink amount of CMYKLcLmLk as an output value associated with the grid point P11 is (20, 20, 10, 30, 0, 0, 60).

As shown in FIG. 8, in step S32, the correction unit 220 executes correction for the black print holding. The processing of step S32 is executed when the black print holding correction needs to be executed. When it is not necessary to execute the black print holding correction, the processing of step S32 is skipped. The case where the black print holding correction needs to be executed means a case where an output value in which a color component other than K is not zero is associated with an input value including only the K component in the color conversion LUT 120. In the color conversion LUT 120, when an output value in which a color component other than K is zero is associated with an input value including only the K component, it is not necessary to execute the black print holding correction. Here, a case where the color component other than K is zero includes not only a case where the color component other than K is strictly zero but also a case where the color component other than K is equal to or less than a predetermined threshold and the color component other than K can be regarded as zero. For the black print holding correction, the correction unit 220 increases the K component in the output value associated with the selected grid point on the K axis, and corrects the color component other than the K component in the output value associated with the grid point to zero. The K value after the correction is calculated, for example, as follows. An L value is calculated using the LUT included in the AtoBTag of the output profile OPF, and the K value is calculated using a 1D curve, which is included in the AtoBTag and represents the association between the L value and the K value. The LUT included in the AtoBTag of the output profile OPF in the memory 101 is preferably about two grids. This is because the output profile OPF cannot be stored in the memory 101 when the LUT included in the AtoBTag has an excessively large size.

In the example shown in FIG. 10, the ink amount of CMYKLcLmLk associated with the grid point P11 of the index (0, 0, 0, 4) is corrected to (0, 0, 0, 50, 0, 0, 0). The correction unit 220 updates the content of the color conversion LUT 120 with the ink amount after the correction. Hereinafter, the corrected grid point on the K axis is referred to as a “target grid point”. When the color component other than the K component in the output value associated with the grid point is zero, the execution of the processing of step S32 is unnecessary.

As shown in FIG. 8, in step S33, the correction unit 220 calculates an increase amount ΔK that is a difference between the K component in the output value associated with the target grid point after the correction and the K component in the output value associated with the target grid point before the correction. The increase amount ΔK is also referred to as a “K increase amount”.

In step S34, the correction unit 220 specifies a “spread grid point” which is one or more grid points in a predetermined range around the target grid point. The spread grid point is a grid point present in a range not exceeding a predetermined maximum distance M from the target grid point. For example, the maximum distance M is “3”. A unit of the distance is an interval of the grid points. In the example shown in FIG. 10, when the grid point P11 of the index (0, 0, 0, 4) is the target grid point, a grid point P12 of an index (1, 0, 0, 4) and a grid point P13 of an index (2, 0, 0, 4) among the grid points on the KC plane correspond to the spread grid points. The grid points P12 and P13 are selected from the plurality of grid points arranged on the KC plane.

Although the grid points on the KC plane are shown in FIG. 10, among the grid points arranged on each of an MC plane, a CY plane, an MK plane, a YM plane, and a YK plane, the grid points present in the range not exceeding the maximum distance M from the target grid point also correspond to the spread grid points.

The spread grid points are not limited to grid points arranged on any of the KC plane, the MC plane, the CY plane, the MK plane, the YM plane, and the YK plane. The index of the target grid point is (C1, M1, Y1, K1). An index of a grid point not arranged on any of the KC plane, the MC plane, the CY plane, the MK plane, the YM plane, and the YK plane is (C2, M2, Y2, K2). Since the spread grid point is affected by the black print holding for the closest target grid point on the K axis, the coordinate value of the target grid point on the K axis and the coordinate value of the spread grid point on the K axis are the same. In this case, a distance D between the target grid point and the grid point of the index (C2, M2, Y2, K2) is obtained by D=SQRT{(C2−C1)²+(M2−M1)²+(Y2−Y1)²+(K2−K1)²}. Here, SQRT (val) represents the square root of a value val. Since the target grid point is on the K axis, C1=M1=Y1=0. Therefore, the distance D between the target grid point and the grid point of the index (C2, M2, Y2, K2) is represented as D=SQRT{C2²+M2²+Y2²+(K2−K1)²}. A grid point for which the distance D is less than the maximum distance M corresponds to a spread grid point. The distance D is also referred to as a “K axis separation distance”.

As shown in FIG. 8, in step S35, the correction unit 220 selects one of the spread grid points specified in step S34 and calculates the distance D from the target grid point to the selected spread grid point. For example, in FIG. 10, the distance D from the target grid point of the index (0, 0, 0, 4) to the grid point P12 of the index (1, 0, 0, 4) is “1”.

As shown in FIG. 8, in step S36, the correction unit 220 calculates a K correction amount K_CV for the selected spread grid point based on the following Formula (1) using the maximum distance M, the increase amount ΔK, and the distance D. The K correction amount decreases as the distance from the target grid point increases. The K correction amount K_CV is also referred to as a “K correction value”.

K_CV=ΔK·(M−D)/M (1)

For example, in FIG. 10, the K correction amount K_CV is calculated as follows for the grid point P12 of the index (1, 0, 0, 4) corresponding to the spread grid point of the target grid point of the index (0, 0, 0, 4). ΔK=20.

K_CV=ΔK·(M−D)/M=20·(3−1)/3=13.33 . . .

As shown in FIG. 8, in step S37, the correction unit 220 selects, from the substitution rate table 130, a record, which includes a composition ratio, close to the composition ratio of the ink amount associated with the spread grid point.

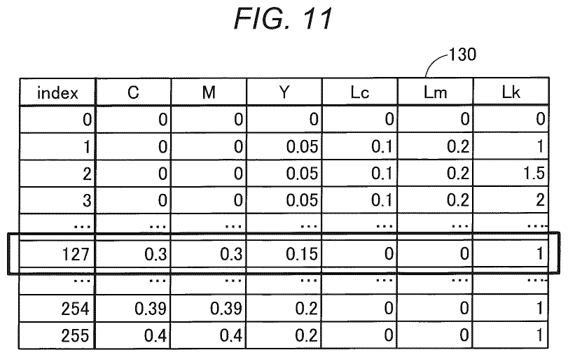

FIG. 11 is a diagram showing an example of the substitution rate table 130. The substitution rate table 130 is used to correct the output value associated with the spread grid point. The substitution rate table 130 defines a combination of the color components other than the K component that can cancel an increase in the K component when the K component in the output value associated with the spread grid point is increased. In the substitution rate table 130, the K axis in the output color space is divided into 256 tones, and a substitution rate of the CMYLcLmLk color component that is as equivalent as possible to the ink amount of the K component for each tone is defined. The substitution rate of the CMYLcLmLk color component is also referred to as a “color component substitution rate”. The substitution rate table 130 includes 256 records. The index of the substitution rate table 130 represents the ink amount of the K component in the output color space. The ink amount takes a value in a range of 0 to 100%, and a value obtained by dividing this range into 256 tones is set as an index. For example, the CMYLcLmLk stored in an index “127” is calculated as follows. When the CMYKLcLmLk value in the output color space is (0, 0, 0, 127, 0, 0, 0), the CMYLcLmLk is calculated by calculating a CMYLcLmLk value, which is a value of a color component as equivalent as possible to a brightness L converted from the output value and which excludes the K value, and dividing the calculated CMYLcLmLk value by “127”. When the device independent color space is the CIE-XYZ color space, first, the CIE-XYZ color space may be converted into the Lab color space using a known conversion formula. Since the K component of the ink is increased in the black print holding correction, the CMYLcLmLk color component is corrected to change the brightness in order to prevent the occurrence of the tone jump in the spread correction.

The record of the substitution rate table 130 is selected by the following method.

First, the correction unit 220 calculates the composition ratio of the ink amount of the color component other than the K component in the output value associated with the selected spread grid point. Specifically, the ink amounts of the other color components are divided by the ink amount of the color component having the maximum ink amount among the color components other than the K component.

For example, the ink amount other than the K component in the output value associated with the selected spread grid point is CMYLcLmLk (30, 20, 10, 0, 0, 60). In this example, an ink amount of an Lk component is the maximum. Therefore, when the ink amounts of the other color components are divided by the ink amount of the Lk component, a composition ratio (0.5, 0.33, 0.17, 0, 0, 1) of the ink amount of the spread grid point is obtained.

The correction unit 220 calculates the composition ratio of the ink amount for each record by dividing the ink amounts of the other color components by the ink amount of the color component having the maximum ink amount for each record of the substitution rate table 130.

The correction unit 220 calculates an absolute value S[i] of a difference between a sum of respective elements of the composition ratio of the ink amount of the selected spread grid point and a sum of respective elements of a composition ratio of an ink amount of a record R[i] (i is an integer) of the substitution rate table 130. The subscript i corresponds to the index of the substitution rate table 130. When the composition ratio of the ink amount of the spread grid point is (0.5, 0.33, 0.17, 0, 0, 1), the sum of the respective elements of the composition ratio of the ink amount of the spread grid point is calculated as 0.5+0.33+0.17+0+0+1=1.01. The sum of the respective elements of the composition ratio of the ink amount of the record R[i] can be similarly calculated. The correction unit 220 calculates the absolute value S[i] of the difference for each of the 256 records of the substitution rate table 130, and selects the record R[i] having a minimum value, among the calculated 256 absolute values S[i] of the differences, as a record close to the composition ratio of the ink amount associated with the spread grid point. For example, when the composition ratio (0.5, 0.33, 0.17, 0, 0, 1) of the ink amount for the spread grid point is obtained, the ink amount (0.3, 0.3, 0.15, 0, 0, 1) of the record of the index “127” of the substitution rate table 130 corresponds to the composition ratio of the ink amount.

As shown in FIG. 9, in step S38, the correction unit 220 calculates a correction amount (DC, DM, DY, DLc, DLm, DLk) other than the K component by multiplying respective elements of an ink amount (RC, RM, RY, RLc, RLm, RLk) of the record selected in step S37 by the K correction amount K_CV calculated in step S26. For example, the record (0.3, 0.3, 0.15, 0, 0, 1) of the index “127” is selected in step S37. K_CV =13.33. In this case, (4, 4, 2, 0, 0, 13.33) is calculated as the correction amount (DC, DM, DY, DLc, DLm, DLk).

In step S39, the correction unit 220 calculates an ink amount (C′, M′, Y′, K′, Lc′, Lm′, Lk′) after the correction of the spread grid point based on the following Formula (2) using an ink amount (C, M, Y, K, Lc, Lm, Lk) before the correction of the spread grid point, the K correction amount K_CV, and the correction amount (DC, DM, DY, DLc, DLm, DLk) other than the K component. In the following Formula (2), the ink amount of only the K component is increased, and the ink amounts of the other color components are decreased.

(C′, M′, Y′, K′, Lc′, Lm′, Lk′)=(C−DC, M−DM, Y−DY, K+K_CV, Lc−DLc, Lm−DLm, Lk−DLk) (2)

As shown in FIG. 10, for example, an ink amount (30, 20, 10, 30, 0, 0, 60) of CMYKLcLmLk is associated with the grid point P12. The K correction amount K_CV is 13.33 and the correction amount (DC, DM, DY, DLc, DLm, DLk) is (4, 4, 2, 0, 0, 13.33). In this case, the ink amount after the correction of the spread grid point is calculated as follows.

(C′, M′, Y′, K′, Lc′, Lm′, Lk′)=(30−4, 20−4, 10−2, 30+13.33, 0−0, 0−0, 60−13.33)=(26, 16, 8, 43.33, 0, 0, 46.67)

The ink amount of CMYKLcLmLk as the output value associated with the grid point P12 is corrected to (26, 16, 8, 43, 0, 0, 47).

The correction unit 220 updates the content of the color conversion LUT 120 with the ink amount after the correction.

In the spread correction, correction of increasing the ink amount of the K component and decreasing the ink amounts other than the K component among the ink amounts associated with the spread grid points is performed. Accordingly, it is possible to spread the black print holding correction to the spread grid points around the K axis on which the black print holding correction is executed.

As shown in FIG. 9, in step S40, it is determined whether the correction processing, that is, the processing of steps S35 to S39 is completed for all the spread grid points specified in step S34. Here, the spread grid point specified in step S34 is the grid point specified in the processing of step S34 executed immediately before. When there is a spread grid point on which the correction processing is not performed (step S40; NO), the processing after step S35 is executed again. When it is determined that the correction processing is performed on all the spread grid points specified in step S34 (step S40; YES), the processing of step S41 is executed.

In step S41, the correction unit 220 determines whether the correction processing, that is, the processing of steps S31 to S39 is completed for all the grid points on the K axis. When there is a grid point on the K axis on which the processing is not performed (step S41; NO), the processing after step S31 is executed again. When the processing is completed for all the grid points on the K axis (step S41; YES), the correction processing of the color conversion LUT 120 in step S30 (see FIG. 6) is completed.

In the embodiment, in the color conversion LUT 120, the black print holding correction is executed by correcting the output value associated with the grid point on the K axis. Further, the spread correction is executed by correcting the output value associated with the spread grid point around the grid point on the K axis in the color conversion LUT 120. By the spread correction, it is possible to prevent the occurrence of the tone jump caused by the black print holding during the color conversion using the color conversion LUT 120.

When the output value associated with the spread grid point is corrected in the color conversion LUT 120, a color value of an image after the color conversion using the color conversion LUT 120 varies compared to the image before the color conversion. Here, the color value refers to three attribute values of the device independent color space. In order to limit the variation of the color value, in the embodiment, the output value associated with the spread grid point is corrected using the substitution rate table 130.

Although it is conceivable to use AtoBTag in order to limit the variation of the color value, it is assumed that the data size of AtoBTag becomes very large in the multicolor profile. For example, AtoBTag is obtained by converting a device color into a Lab value, the number of grids indicating the number of grid points on each axis of a device color space is 17, and the number of color channels is 7 because the type of the color material of the printing device is 7. In this case, a total number of grid points is 17\hat{ }7=410,338,673. As the number of grid points increases, the data size of AtoBTag becomes very large. In the embodiment, the substitution rate table 130 is used instead of AtoBTag having a very large data size. In the substitution rate table 130, an ink substitution rate is defined for the non-target color component for each of 256 tones. The number of dimensions of the substitution rate table 130 is smaller than the number of dimensions of AtoBTag. Therefore, a size of data stored in a color profile can be made compact.

### B. Other Embodiments

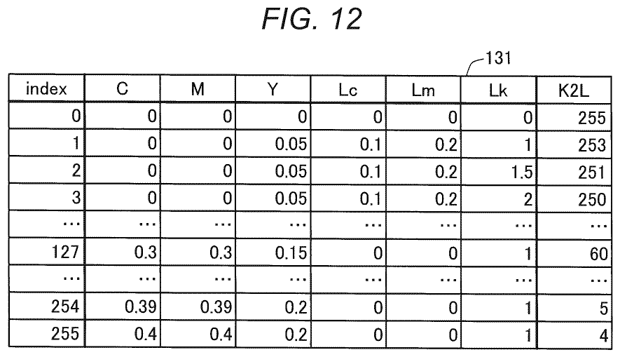

(B1) FIG. 12 is a diagram showing an example of a substitution rate table 131 partially different in configuration from the embodiment. The substitution rate table 131 includes a column of K2L in addition to the columns included in the substitution rate table 130 (see FIG. 11). A value of the column of K2L represents a brightness. The brightness L takes a value in a range of 0 to 100, and a value obtained by dividing this range into 256 tones is set in the column of K2L. As described above, the value of the index represents the ink amount of the K component in the output color space. The ink amount of the K component can be acquired by selecting, from the substitution rate table 131, a record having an index matching the brightness L obtained by converting the CMYK color space into the Lab color space using the profile for the input device, and referring to the value of the index of the selected record. The acquired ink amount of the K component is also referred to as an “updated ink amount”.

In the substitution rate table 131, since the ink amount of the K component corresponding to the brightness in the device independent color space based on the input value is defined in the substitution rate table, the ink amount of the K component can be easily acquired during the correction for the black print holding.

(B2) In the above embodiment, an example has been described in which the ink amount of black is increased when the black print holding correction is executed. However, the ink amount of at least one of black and light black may be increased during the black print holding correction. In the black print holding correction, an increase amount of each of K and Lk is determined according to a grid point value on the K axis representing the input value. In the black print holding correction, when the value of the K component is close to 100, for example, when the input value is K=90, only K may be increased. When the value of the K component is close to 0, for example, when the input value is K=10, only Lk may be increased. When the value of the K component is an intermediate value in the range of 0 to 100, for example, when the input value is K=45, K and Lk may be increased. By using K and Lk in combination, graininess of a printed image, that is, roughness of the image can be reduced.

When the printing device 400 uses an ink of LLk, an ink amount of at least one of black, light black, and light light black may be increased during the black print holding correction. LLk is light light black. The light light black is a black ink having a density lower than the light black. K, Lk, and LLk are included in the ink of the K component. In the black print holding correction, an increase amount of each of K, Lk, and LLk is determined according to a grid point value on the K axis representing the input value.

(B3) In the above embodiment, an example has been described in which the K axis in the output color space is divided into 256 tones and the substitution rate of the CMYLcLmLk color component for each tone is defined in the substitution rate table 130. The K axis may be divided into 128 tones to define the substitution rate table 130. In this case, the size of the substitution rate table 130 can be made compact as compared with an aspect in which the K axis is divided into 256 tones. The K axis may be divided into 512 tones to define the substitution rate table 130. In this case, since the substitution rate is defined more finely than in the aspect in which the K axis is divided into 256 tones, it is possible to more finely control to limit the color variation caused by the spread correction.

(B4) The method related to the black print holding correction and the spread correction according to the above embodiment can also be adopted when the input color space is an RGB color space. In the color conversion LUT 120 before the correction, when the input value is R=G=B, the input value is regarded as a single-color input value including only the K component. When the black print holding is instructed, in the color conversion LUT before the correction, when the input value is R=G=B and the output value associated with the input value includes a color component other than the K component, that is, a non-target color component, the color conversion LUT is corrected by increasing the K component in the output value and decreasing at least one color component other than the K component in the output value. The K value corresponding to the input value in the RGB color space as the input color space can be obtained by converting the input value into the CMYK color space. For example, when the input value R=G=B=0 is converted into the CMYK color space, C=M=Y=0 and K=100. Further, the spread correction is executed by correcting the output value associated with the spread grid point in the predetermined range around the grid point of R=G=B.

The method related to the black print holding correction and the spread correction according to the above embodiment can also be adopted when the input color space is a CMY color space. In the color conversion LUT 120 before the correction, when the input value is C=M=Y, the input value is regarded as a single-color input value including only the K component. When the black print holding is instructed, in the color conversion LUT before the correction, when the input value is C=M=Y and the output value associated with the input value includes a non-target color component, the color conversion LUT is corrected by increasing the K component in the output value and decreasing at least one color component other than the K component in the output value. When the input color space is the CMY color space, the K value corresponding to the input value in the CMY color space can be obtained by a known method. Further, the spread correction is executed by correcting the output value associated with the spread grid point in the predetermined range around the grid point of C=M=Y.

(B5) In the above embodiment, an example of preventing the occurrence of the tone jump caused by the black print holding has been described. The correction method of the color conversion LUT 120 described in the above embodiment can also be adopted when pure color holding is executed for color components other than the K component. The pure color holding means that, when the input value includes only one color component of C, M, Y, and K, only an ink of a color corresponding to the color component is output. The black print holding is also one of the pure color holding. For example, when the input value includes only the C component, the ink amounts of the color components other than the C component in the output value are set to zero. The ink of the C component may contain not only C but also Lc. For example, the pure color holding is executed for the C component. In this case, the substitution rate table 130 corresponding to the C component as a target is prepared in advance. An output value associated with a target grid point on the C axis is corrected, and an output value associated with a spread grid point present in a predetermined range around the target grid point is corrected. As a result, the occurrence of the tone jump can be prevented.

(B6) The printing device 400 may be capable of executing printing using an ink of a special color. The special color is a color, such as orange, red, green, violet, and blue, other than the process color CMYK. Lc (light cyan), Lm (light magenta), Lk (light black), and LLk (light light black) are not special colors but process colors.

The printing device 400 may be capable of executing printing using inks of four color of CMYK. The method according to the above embodiment can also be adopted when the ink used by the printing device 400 is not multicolor. The method according to the above embodiment is more effective when the printing device 400 uses the multicolor ink than when the four-color ink.

### C. Other Aspects

The present disclosure is not limited to the above embodiment, and can be implemented in various forms without departing from the scope of the present disclosure. For example, the present disclosure may also be implemented in the following aspects. The technical features in the above embodiment corresponding to the technical features in the aspects described below can be replaced or combined as appropriate in order to solve a part or all of the problems of the present disclosure, or to achieve a part or all of the advantages of the present disclosure. Further, any of the technical features can be eliminated as appropriate unless described as essential in the present specification.
(1) According to a first aspect of the present disclosure, a color conversion method is provided. The color conversion method includes: (a) receiving an instruction to hold black print; (b) preparing a color conversion table defining an association between an input value in an input color space in image data and an output value in an output color space in a printing device that prints an image represented by the image data; (c) when the instruction is received and a single-color input value that is the input value including only a K component in the image data is converted into the output value including a non-target color component that is a color component other than the K component by color conversion using the color conversion table, executing black print holding correction for correcting the color conversion table to increase the K component and decrease the non-target color component in the output value associated with a target grid point that is a grid point representing the single-color input value in the color conversion table; and (d) executing spread correction for spreading the black print holding correction to a spread grid point in a predetermined range around the target grid point among grid points representing the input value in the color conversion table, which is spread correction for correcting the output value associated with the spread grid point in the color conversion table by using an increase amount of the K component caused by the black print holding correction and a substitution rate table in which a color component substitution rate is defined for the non-target color component to limit a color variation caused by the spread correction.

According to the above aspect, when the black print holding is performed, the spread correction for spreading the black print holding to the output value associated with the spread grid point around the target grid point is executed on the color conversion table. Accordingly, it is possible to prevent occurrence of tone jump caused by the black print holding during the color conversion using the color conversion table after the correction. In order to limit the color variation caused by the spread correction, the output value converted from the input value including the non-target color component in the color conversion table is corrected using the substitution rate table defining the color component substitution rate for the non-target color component other than the K component. Therefore, it is possible to limit the color variation caused by the spread correction.
(2) In the color conversion method according to the above aspect, the output color space may be a color space including at least the K component, and the color component substitution rate of the non-target color component for each tone may be defined in the substitution rate table when a K axis in the output color space is divided into a plurality of tones.

For example, AtoBTag is used for converting a CMYK value into a Lab value, the number of grids indicating the number of grid points on each axis of a CMYK color space is 17, and the number of color channels is 7 because the type of the color material of the printing device is 7. In this case, a total number of grid points is 17\hat{ }=410,338,673. It is assumed that a data size of AtoBTag becomes very large as the number of grid points increases. In the substitution rate table used in the above aspect, the color component substitution rate is defined for the non-target color component for each tone when the K axis in the output color space is divided into 256 tones. In the above aspect, instead of using AtoBTag having a very large data size, a compact substitution rate table can be used to limit the color variation caused by the spread correction. Since the number of dimensions of the substitution rate table is smaller than the number of dimensions of AtoBTag, data stored in a color profile can be reduced.
(3) In the color conversion method according to the above aspect, in the (d), a record, in which a color component composition ratio for the non-target color component of the output value associated with the spread grid point in the color conversion table is defined, close to the color component composition ratio may be selected from the substitution rate table, and the output value associated with the spread grid point in the color conversion table may be corrected using the increase amount of the K component caused by the black print holding correction and the selected record.

According to the above aspect, by selecting the substitution rate of the configuration of the color component represented by the output value associated with the grid point in the color conversion LUT, it is possible to limit a variation of a color value caused by the spread correction during the color conversion using the color conversion table after the correction.
(4) In the color conversion method according to the above aspect, the (d) may include (d1) calculating a K increase amount that is the increase amount of the K component caused by the black print holding correction, (d2) calculating a K axis separation distance that is a distance between the target grid point and the spread grid point in the input color space, (d3) calculating, as a K correction value, a value obtained by decreasing the K increase amount according to the K axis separation distance, (d4) calculating a correction value for each ink color excluding the K component by multiplying the K correction value by each of the color component substitution rates for the non-target color components defined in the record selected from the substitution rate table, (d5) adding the K correction value to a K value in the output value associated with the spread grid point in the color conversion table, and (d6) subtracting the correction value from a color value representing a color component excluding the K component in the output value associated with the spread grid point in the color conversion table.
(5) In the color conversion method according to the above aspect, the output value defined in the color conversion table may represent an ink amount of each ink color, the ink amount of the K component in the output color space for each tone may be further defined in the substitution rate table, in the (c), the single-color input value representing the target grid point in the color conversion table may be converted into a brightness in a device independent color space, the ink amount of the K component corresponding to the brightness may be acquired as an updated ink amount from the substitution rate table, the ink amount of the K component in the output value associated with the target grid point in the color conversion table may be updated with the updated ink amount, and an ink amount of the non-target color component in the output value associated with the target grid point in the color conversion table may be set to zero.

According to the above aspect, the ink amount of the K component can be easily acquired during the black print holding correction.
(6) According to a second aspect of the present disclosure, a color conversion device is provided. The color conversion device includes: a selection unit configured to receive an instruction to hold black print; a table creation unit configured to create a color conversion table defining an association between an input value in an input color space in image data and an output value in an output color space in a printing device that prints an image represented by the image data; and a correction unit configured to, when the instruction is received and a single-color input value that is the input value including only a K component in the image data is converted into the output value including a non-target color component that is a color component other than the K component by color conversion using the color conversion table, execute black print holding correction for correcting the color conversion table to increase the K component and decrease the non-target color component in the output value associated with a target grid point that is a grid point representing the single-color input value in the color conversion table, and execute spread correction for spreading the black print holding correction to a spread grid point in a predetermined range around the target grid point among grid points representing the input value in the color conversion table, which is spread correction for correcting the output value associated with the spread grid point in the color conversion table by using an increase amount of the K component caused by the black print holding correction and a substitution rate table in which a color component substitution rate is defined for the non-target color component to limit a color variation caused by the spread correction.
(7) According to a third aspect of the present disclosure, a program executed by a computer is provided. A non-transitory computer-readable storage medium storing the program for causing the computer to execute: a function of receiving an instruction to hold black print; a function of creating a color conversion table defining an association between an input value in an input color space in image data and an output value in an output color space in a printing device that prints an image represented by the image data; and when the instruction is received and a single-color input value that is the input value including only a K component in the image data is converted into the output value including a non-target color component that is a color component other than the K component by color conversion using the color conversion table, a function of executing black print holding correction for correcting the color conversion table to increase the K component and decrease the non-target color component in the output value associated with a target grid point that is a grid point representing the single-color input value in the color conversion table, and a function of executing spread correction for spreading the black print holding correction to a spread grid point in a predetermined range around the target grid point among grid points representing the input value in the color conversion table, which is spread correction for correcting the output value associated with the spread grid point in the color conversion table by using an increase amount of the K component caused by the black print holding correction and a substitution rate table in which a color component substitution rate is defined for the non-target color component to limit a color variation caused by the spread correction.

The present disclosure can also be implemented in various forms other than the color conversion method, the color conversion device, and the program executed by the computer. For example, the present disclosure can be implemented in the form of an image processing method or a non-transitory storage medium on which a computer program is stored.

What is claimed is:

1. A color conversion method comprising:
(a) receiving an instruction to hold black print;
(b) preparing a color conversion table defining an association between an input value in an input color space in image data and an output value in an output color space in a printing device that prints an image represented by the image data;
(c) when the instruction is received and a single-color input value that is the input value including only a K component in the image data is converted into the output value including a non-target color component that is a color component other than the K component by color conversion using the color conversion table, executing black print holding correction for correcting the color conversion table to increase the K component and decrease the non-target color component in the output value associated with a target grid point that is a grid point representing the single-color input value in the color conversion table; and
(d) executing spread correction for spreading the black print holding correction to a spread grid point in a predetermined range around the target grid point among grid points representing the input value in the color conversion table, which is spread correction for correcting the output value associated with the spread grid point in the color conversion table by using an increase amount of the K component caused by the black print holding correction and a substitution rate table in which a color component substitution rate is defined for the non-target color component to limit a color variation caused by the spread correction.

2. The color conversion method according to claim 1, wherein
the output color space is a color space including at least the K component, and
the color component substitution rate of the non-target color component for each tone is defined in the substitution rate table when a K axis in the output color space is divided into a plurality of tones.

3. The color conversion method according to claim 2, wherein
in the (d), a record, in which a color component composition ratio for the non-target color component of the output value associated with the spread grid point in the color conversion table is defined, close to the color component composition ratio is selected from the substitution rate table, and
the output value associated with the spread grid point in the color conversion table is corrected using the increase amount of the K component caused by the black print holding correction and the selected record.

4. The color conversion method according to claim 3, wherein
the (d) includes
(d1) calculating a K increase amount that is the increase amount of the K component caused by the black print holding correction,
(d2) calculating a K axis separation distance that is a distance between the target grid point and the spread grid point in the input color space,
(d3) calculating, as a K correction value, a value obtained by decreasing the K increase amount according to the K axis separation distance,
(d4) calculating a correction value for each ink color excluding the K component by multiplying the K correction value by each of the color component substitution rates for the non-target color components defined in the record selected from the substitution rate table,
(d5) adding the K correction value to a K value in the output value associated with the spread grid point in the color conversion table, and
(d6) subtracting the correction value from a color value representing a color component excluding the K component in the output value associated with the spread grid point in the color conversion table.

5. The color conversion method according to claim 4, wherein
the output value defined in the color conversion table represents an ink amount of each ink color,
the ink amount of the K component in the output color space for each tone is further defined in the substitution rate table,
in the (c),
the single-color input value representing the target grid point in the color conversion table is converted into a brightness in a device independent color space,
the ink amount of the K component corresponding to the brightness is acquired as an updated ink amount from the substitution rate table,
the ink amount of the K component in the output value associated with the target grid point in the color conversion table is updated with the updated ink amount, and
an ink amount of the non-target color component in the output value associated with the target grid point in the color conversion table is set to zero.

6. A color conversion device comprising:
a selection unit configured to receive an instruction to hold black print;
a table creation unit configured to create a color conversion table defining an association between an input value in an input color space in image data and an output value in an output color space in a printing device that prints an image represented by the image data; and
a correction unit configured to
when the instruction is received and a single-color input value that is the input value including only a K component in the image data is converted into the output value including a non-target color component that is a color component other than the K component by color conversion using the color conversion table,
execute black print holding correction for correcting the color conversion table to increase the K component and decrease the non-target color component in the output value associated with a target grid point that is a grid point representing the single-color input value in the color conversion table, and
execute spread correction for spreading the black print holding correction to a spread grid point in a predetermined range around the target grid point among grid points representing the input value in the color conversion table, which is spread correction for correcting the output value associated with the spread grid point in the color conversion table by using an increase amount of the K component caused by the black print holding correction and a substitution rate table in which a color component substitution rate is defined for the non-target color component to limit a color variation caused by the spread correction.

7. A non-transitory computer-readable storage medium storing a program for causing a computer to execute:
a function of receiving an instruction to hold black print;
a function of creating a color conversion table defining an association between an input value in an input color space in image data and an output value in an output color space in a printing device that prints an image represented by the image data; and
when the instruction is received and a single-color input value that is the input value including only a K component in the image data is converted into the output value including a non-target color component that is a color component other than the K component by color conversion using the color conversion table,
a function of executing black print holding correction for correcting the color conversion table to increase the K component and decrease the non-target color component in the output value associated with a target grid point that is a grid point representing the single-color input value in the color conversion table, and
a function of executing spread correction for spreading the black print holding correction to a spread grid point in a predetermined range around the target grid point among grid points representing the input value in the color conversion table, which is spread correction for correcting the output value associated with the spread grid point in the color conversion table by using an increase amount of the K component caused by the black print holding correction and a substitution rate table in which a color component substitution rate is defined for the non-target color component to limit a color variation caused by the spread correction.
